(19) United States
(12) Patent Application Publication
(10) Pub. No.: US 2013/0053502 A1
(43) Pub. Date: Feb. 28, 2013

(54) RECYCLED THERMOPLASTIC WITH FUNCTIONALIZED RUBBER

(71) Applicant: Avelino F. Lima, North Hills, WV (US)

(72) Inventor: Avelino F. Lima, North Hills, WV (US)

(73) Assignee: E I DU PONT DE NEMOURS AND COMPANY, Wilmington, DE (US)

(21) Appl. No.: 13/590,228

(22) Filed: Aug. 21, 2012

Related U.S. Application Data
(60) Provisional application No. 61/525,931, filed on Aug. 22, 2011.

(51) Int. Cl. C08L 77/06; C08K 7/14

(52) U.S. Cl. 524/514

(57) ABSTRACT

Disclosed is a thermoplastic composition including
a) a recycled thermoplastic comprising polyamide resin, polyolefin and mineral filler, wherein said recycled thermoplastic comprises at least 60 weight percent content of recycled polyamide and at least 4 weight per cent content of polyolefin;
b) 2 to 8 weight percent of a functionalized rubber;
c) 2 to less than 10 weight percent reinforcing agent; and
d) 0 to 5 weight percent of additives selected from the group.
   consisting of mold release, flow enhancers, thermal stabilizers, antistatic agents, blowing agents, lubricants, plasticizers, and colorant and pigments; wherein the weight percents of a), b), c), and d) are based on the total weight of the thermoplastic resin composition

### CROSS REFERENCE TO RELATED APPLICATIONS

This applications claims priority of application Ser. No. 61/525,931, filed Aug. 22, 2011.

### FIELD OF INVENTION

The present invention relates to the field of recycled thermoplastic including polyamide; and a functionalized rubber.

### BACKGROUND OF INVENTION

The recycle of thermoplastics is potentially a cost effective, and resource efficient pathway to a variety of molded thermoplastic parts. Recycled thermoplastic can be derived from many sources. One of the more plentiful and less expensive sources is polyamide 6,6 derived from carpet, such as manufacturing waste, referred to as post industrial polyamide 66 (PI PA66), or post consumer recycle polyamide 6,6 (PCR PA66).

It is well known that polyamide PCR PA66 presents challenges to create products that can replace virgin polyamide 66 (PA66) as well as post industrial PA66 due to difficulty to create a pure stream of PA66.

In the marketplace there is polyamide PCR PA66 having purities ranging from 60% to 99% nylon content. This source of polymer has been used successfully in reinforced applications. For instance U.S. Pat. No. 6,756,412 discloses a fiber reinforced thermoplastic composite.

### SUMMARY OF INVENTION

Disclosed is a thermoplastic composition comprising
a) 80 to 96 weight percent of a recycled thermoplastic comprising polyamide resin, polyolefin and mineral filler, wherein said recycled thermoplastic comprises at least 60 weight percent content of recycled polyamide selected from the group consisting of polyamide 66, polyamide 6, blends of polyamide 66 and polyamide 6, and copolymers having repeat units of polyamide 66 and polyamide 6; and at least 4 weight per cent content of polyolefin, and wherein said recycled polyamide content is equal to the per cent nitrogen content as compared to the nitrogen content of a pure polyamide 66 standard, said nitrogen content being determined by a Nitrogen Combustion Analysis Determination Method; and said polyolefin content is as determined by subtraction of the polyamide content and mineral filler content, as determined from Nitrogen combustion analysis and Ash Analysis, respectively, from the total weight of recycled thermoplastic;
b) 2 to 8 weight percent of a functionalized rubber;
c) 2 to less than 10 weight percent reinforcing agent having a minimum aspect ratio of 3; and
d) 0 to 5 weight percent of additives selected from the group. consisting of mold release, flow enhancers, thermal stabilizers, antistatic agents, blowing agents, lubricants, plasticizers, and colorant and pigments;
wherein the weight percents of a), b), c), and d) are based on the total weight of the thermoplastic resin composition.

Another embodiment is a process for recycling a thermoplastic comprising

melt blending and forming a pellet or molded article from said melt blend.

### DETAILED DESCRIPTION

The thermoplastic composition comprises a recycled thermoplastic comprising polyamide resin, polyolefin and mineral filler. The recycled thermoplastic comprises at least 60 weight percent content of recycled polyamide, and preferably at least 65 weight percent, and more preferably at least 68 weight percent recycled polyamide. The recycled polyamide is selected from the group consisting of polyamide 66, polyamide 6, blends of polyamide 66 and polyamide 6,and copolymers having repeat units of polyamide 66 and polyamide 6. The recycled polyamide content in the thermoplastic composition herein is considered equal to the per cent nitrogen content as compared to the nitrogen content of a pure polyamide 66 standard, the nitrogen content being determined by a Nitrogen Combustion Analysis Determination Method. For instance, if pure PA 66 is determined to have a nitrogen content of 12.4 per cent, and the recycled thermoplastic is determined to have a nitrogen content of 10.0 per cent, then the recycled thermoplastic is considered to have:

10.0%/12.4%=80.6% recycled polyamide.

A suitable standard PA 66 is, for instance, PA 66 commercially available as Zytel® ZYT101 NC010 polyamide 66 resin available from E. I. du Pont de Nemours & Co., Inc.

The recycled polyamide may comprise at least 90 weight percent, or at least 95 weight percent, of polyamide 66 and/or polyamide 6. The recycled polyamide may comprise at most 98 weight percent of polyamide 66 and/or polyamide 6. Polyamide 66 refers to poly(hexamethylene hexanediamide). Polyamide 6 refers to poly(caprolactam).

The recycled thermoplastic comprises at least 4 weight per cent content, preferably at least 8 weight percent, and more preferably at least 10 weight percent, of polyolefin. Preferably the recycled thermoplastic comprises no more than 30 weight percent polyolefin, and more preferably, no more than 25, 20 or 18 weight percent polyolefin. The polyolefin content is determined by subtraction of the polyamide content, as determined from nitrogen analysis, and mineral filler content, as determined with combustion ash analysis, from the total weight of recycled thermoplastic. The polyolefin may be a homopolymer or copolymer comprising repeat units derived from polymerization of a C2-C8 alpha-olefin, alkyldienes, and styrene and alpha-methyl styrene. The polyolefin may be selected from the group consisting of polyethylene, polypropylene, polyethylene copolymers, polypropylene copolymers and styrene-butadiene copolymers. In one embodiment the polyolefin is polypropylene.

The recycled thermoplastic is preferably derived from recycled carpet and/or carpet fiber. A source of the recycled thermoplastic polyamide useful in the thermoplastic composition is referred to as post consumer recycled (PCR) polyamide.

The PCR polyamide comprises at least 60 weight percent polyamide; with the remainder weight percent comprising polyolefin, rubber, fillers, and/or other additives commonly used in carpets. The presence of polyolefin is indicated by a melt transition peak lower than 170° C. measured in accordance with ISO 11357 evident in the differential scanning calorimetry (DSC) of the recycled thermoplastic. The mineral filler content is established by Ash analysis test run for 25 min at 600° C. The mineral filler may be calcium carbonate.

Suitable PCR PA66 materials have a relative viscosity of at least 30, as determined with ASTM D789 method.

The functionalized rubber is a polymer, typically an elastomer having a melting point and/or glass transition points below 25° C., or is rubber-like, i.e., has a heat of melting (measured by ASTM Method D3418-82) of less than about 10 J/g, more preferably less than about 5 J/g, and/or has a melting point of less than 80° C., more preferably less than about 60° C. Preferably the functionalized rubber has a weight average molecular weight of about 5,000 or more, more preferably about 10,000 or more, when measured by gel permeation chromatography using polyethylene standards.

The functionalized rubber is present at 2 to 8 weight percent of the total weight of the thermoplastic composition. Preferably the functionalized rubber is present at 2 to 6 weight percent, and more preferably, 2 to 5 weight per cent of the total weight of the thermoplastic composition.

A functionalized rubber has attached to it reactive functional groups which can react with the polyamide. Such functional groups are usually “attached” to the functionalized rubber by grafting small molecules onto an already existing polymer or by copolymerizing a monomer containing the desired functional group when the functionalized rubber molecules are made by copolymerization. As an example of grafting, maleic anhydride may be grafted onto a hydrocarbon rubber (such as an ethylene/α-olefin copolymer, an α-olefin being a straight chain olefin with a terminal double bond such a propylene or 1-octene) using free radical grafting techniques. The resulting grafted polymer has carboxylic anhydride and/or carboxyl groups attached to it.

Ethylene copolymers are an example of a functionalized rubber wherein the functional groups are copolymerized into the polymer, for instance, a copolymer of ethylene and a (meth)acrylate monomer containing the appropriate functional group. Herein the term (meth)acrylate means the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl (meth)acrylate. In addition to ethylene and a functionalized (meth)acrylate monomer, other monomers may be copolymerized into such a polymer, such as vinyl acetate, unfunctionalized (meth)acrylate esters such as ethyl (meth)acrylate, n-butyl (meth)acrylate, i-butyl (meth)acrylate and cyclohexyl (meth)acrylate. Functionalized rubbers include those listed in U.S. Pat. No. 4,174,358, which is hereby incorporated by reference.

Another functionalized rubber is a polymer having carboxylic acid metal salts. Such polymers may be made by grafting or by copolymerizing a carboxyl or carboxylic anhydride containing compound to attach it to the polymer. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

Functionalized rubbers useful in the invention include those selected from the group consisting of linear low density polyethylene (LLDPE) or linear low density polyethylene grafted with an unsaturated carboxylic anhydride, ethylene copolymers; ethylene/α-olefin or ethylene/α-olefin/diene copolymer grafted with an unsaturated carboxylic anhydride; core-shell polymers.

Herein the term ethylene copolymers include ethylene terpolymers and ethylene multi-polymers, i.e. having greater than three different repeat units. Ethylene copolymers useful as polymeric tougheners in the invention include those selected from the group consisting of ethylene copolymers of the formula E/X/Y wherein:
E is the radical formed from ethylene;
X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer;

Y is one or more radicals formed from monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl (meth)acrylate, 2-hydroxyethyl (meth)acrylate, 2-isocyanatoethyl (meth)acrylate and glycidyl vinyl ether; wherein Y is from 0.5 to 35 weight % of the E/X/Y copolymer, and preferably 0.5-20 weight percent of the E/X/Y copolymer, and E is the remainder weight percent and preferably comprises 40-90 weight percent of the E/X/Y copolymer.

It is preferred that the functionalized rubber contain a minimum of about 0.5, more preferably 1.0, very preferably about 2.5 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the functionalized rubber. In one embodiment the polymeric toughener comprises about 0.5 to about 10 weight percent of repeat units and/or grafted molecules containing functional groups or carboxylate salts (including the metal).

Useful functionalized rubbers include:
(a) A copolymer of ethylene, glycidyl (meth)acrylate, and optionally one or more (meth)acrylate esters.
(b) An ethylene/α-olefin or ethylene/α-olefin/diene (EPDM) copolymer grafted with an unsaturated carboxylic anhydride such as maleic anhydride.
(c) A copolymer of ethylene, 2-isocyanatoethyl (meth)acrylate, and optionally one or more (meth)acrylate esters.
(d) a copolymer of ethylene and acrylic acid reacted with a Zn, Li, Mg or Mn compound to form the corresponding ionomer.

The thermoplastic composition comprises 2 to less than 10 weight percent reinforcing agent having an aspect ratio of at least 3. For instance, 2 to 9.9, 2 to 9.5, 2 to 9.0, or 2 to 8.0 weight percent reinforcing agent may be present. The reinforcement agent may be selected from the group consisting of glass fibers with circular and noncircular cross-section, glass flakes, carbon fibers, talc, mica, wollastonite, and mixtures thereof.

Glass fibers with noncircular cross-section refer to glass fiber having a cross section having a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape, a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 3:1 and about 300:1. The ratio is more preferably between about 20:1 and 300:1 and yet more preferably between about 50:1 to about 300:1. Suitable glass fiber are disclosed in EP 0 190 001 and EP 0 196 194.

Preferred reinforcing agents include glass fibers and the minerals such as mica, wollastonite and. Glass fiber is a preferred reinforcing agent.

The thermoplastic composition may include 0 to 5 weight percent of additives selected from the group consisting of mold release (e.g. aluminum distearate, [AlSt]), flow enhancers (e.g. phthalic anhydride, adipic acid, dodecanedioic acid, or terephthalic acid), thermal stabilizers (e.g. potassium halides/Cul/AlSt triblends and hindered phenols, antistatic agents, blowing agents, lubricants, plasticizers, and colorant and pigments.

The thermoplastic composition may include other fillers including clay, calcium carbonate, and glass beads. Clay may be present at, for instance, about 2 to 15 weight percent of the thermoplastic composition.

The thermoplastic composition is a mixture by melt-blending, in which all polymeric ingredients are adequately mixed, and all non polymeric ingredients are adequately dispersed in a polymer matrix.

Another embodiment is a process for recycling a thermoplastic comprising melt blending:
a) 80 to 96 weight percent of a recycled thermoplastic comprising polyamide resin, polypropylene and mineral filler, wherein said recycled thermoplastic comprises at least 60 weight percent content of recycled polyamide selected from the group consisting of polyamide 66, polyamide 6, blends of polyamide 66 and polyamide 6, and copolymers having repeat units of polyamide 66 and polyamide 6; and at least 4 weight per cent content of polyolefin, and wherein said recycled polyamide content is equal to the per cent nitrogen content as compared to the nitrogen content of a pure polyamide 66 standard, said nitrogen content being determined by a Nitrogen Combustion Analysis Determination Method; and said polyolefin content is as determined by subtraction of the polyamide content and mineral filler content, as determined from Nitrogen combustion analysis and Ash

Analysis, respectively, from the total weight of recycled thermoplastic;
b) 2 to 8 weight percent of a functionalized rubber;
c) 2 to less than 10 weight percent reinforcing agent having a minimum aspect ratio of 3; and
d) 0 to 5 weight percent of additives selected from the group. consisting of mold release, flow enhancers, thermal stabilizers, antistatic agents, blowing agents, lubricants, plasticizers, and colorant and pigments;
   wherein the weight percents of a), b), c), and d) are based on the total weight of the thermoplastic resin composition; and forming a pellet or molded article from said melt blend.

The preferences for said recycled polyamide, functionalized rubber and reinforcing agent in the process are the same as stated above for the thermoplastic composition. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches.

When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. Extrusion of the melt-blend through a plurality of orifices provides strands that may be chopped to provide pellets.

Another embodiment is the thermoplastic composition comprising components a) thru d), as disclosed above, wherein said thermoplastic composition has a tensile strength, as measured with the ISO 527-1/-2 at 23 C and strain rate of 5 mm/min, of no less than that of the same composition absent the functionalized rubber. Preferably the tensile strength is at least 5% higher than that of the same composition absent the functionalized rubber.

Another embodiment is a shaped article comprising the thermoplastic composition as disclosed above. Shaped articles include injection molded blow molded and extruded articles.

### Methods

### Compounding and Molding Methods

The compositions listed in Table 1 and 2 were fed to the rear of a 58 mm co-rotating twin screw extruder fitted with a moderately hard working screw, while glass fiber and mineral were fed to barrel #6 through a downstream side-feeder. All states were run at 300 rpm with a 500 lb/hr feed rate. The barrels temperature was set at 278-293° C.

### Sample Preparation and Physical Testing

The compositions were pelletized after exiting the extruder. After drying pellets overnight using a nitrogen bleed, the pellets were injection molded in a Demag #2 injection molding machine at a melt temperature of 287-293° C. and a mold temperature of 77-83° C. to provide 4 mm ISO all-purpose bars. The bars were vacuum sealed in a foil lined plastic bag to preserve them in the dry-as-molded (DAM) condition until they were cut and after conditioning in accordance with ISO 179 Method.

Tensile strength, elongation at break, and tensile modulus were tested dry as molded on a tensile tester by ISO 527-1/-2 at 23° C. and strain rate of 5 mm/min.

Heat deflection temperature was measured at 1.8 MPa in accordance with ISO 75.

Melt viscosity (MV) of all Examples were measured using a Kayeness rheometer. All samples were conditioned to moisture content of 0.11 to 0.15 prior testing.

### Nitrogen Determination Method

This method is applicable to the direct measurement of nitrogen in nylon and other raw materials. For % nitrogen, the calculation is based on the N content of PA 66 (theoretical 12.38% N). An example of a pure polyamide 66 standard is Zytel® 101 resin available from E. I. du Pont de Nemours & Co., Inc. Wilmington, Del., USA. Method calculations can be used to report results as wt % nylon, and/or wt % nitrogen.

Recycled thermoplastic pellets are combusted in the LECO furnace at 850-950° C. Combustion gases are filtered, water vapor is removed and the nitrogen oxides are reduced to N₂ gas in the reduction furnace. Thermal conductivity detection is used to detect and quantify the N₂ gas produced. The analyzer is standardized using the base nylon characteristic of the compounded resin pellets (PA 66). Since rubber tougheners and other non-nylon ingredients do not contribute nitrogen, the measured decrease in detected nitrogen relative to the base nylon standard is proportional to non-nylon content concentration.

Ash Determination was measured after heating for 25 min at 600° C. to avoid calcium carbonate decomposition which occurs at temperatures over 600° C.

### Materials

Polyamide 66 refers to Zytel® ZYT101 NC010 polyamide 66 resin available from E. I. du Pont de Nemours & Co., Inc. (Wilmington, Del., USA).

Polyamide 6 refers to Ultramid® B27 polyamide 6 resin available from BASF Corporation, Florham Park, N.J., 07932.

PCR-1 PA 66 refers post consumer recycled polyamide 66, having a polyamide 66 content based on nitrogen analysis of 75 weight percent and polypropylene content of about 15 weight per cent, derived from post consumer recycled carpet, available from Columbia Recycling Corp., Dalton, Ga. 30722.

PCR-2 PA 66 refers to N-66S-B post consumer recycled polyamide 66, having a polyamide 66 content based on nitrogen analysis of 97 weight percent and less than 1 weight per cent of polypropylene, derived from post consumer recycled carpet, available from Shaw Industries, 330 Brickyard Rd., Dalton, Ga. 30720.

Functionalized rubber-1 refers to Surlyn® 1544P ionomer copolymer available from E.I. DuPont de Nemours and Company, Wilmington, Del., USA.

Functionalized rubber-2 refers to TRX®301E copolymer, a maleic anhydride modified ethylene/octane copolymer available from E.I. DuPont de Nemours and Company, Wilmington, Del., USA.

Glass Fiber refers to PPG3540-1R chopped glass fiber available fro PPG Industries, Pittsburgh, Pa.

Clay refers to Satintone® W calcined clay without surface treatment supplied by BASF.

C-Black refers to ZYTEL® FE310003 black concentrate, a 45 weight % carbon black in PA 66, provided by E. I. du Pont de Nemours & Co., Inc. (Wilmington, Del., USA).

Copper HS is a heat stabilizer consisting of 7 parts potassium bromide, 1 part cuprous (I) iodide and 0.5 part aluminum distearate was purchased from Shepherd Chemical Co. 4900 Beech Street, Norwood, Ohio 45212.

Lubricant refers to aluminum stearate purchased from Chemtura Corporation, Middlebury, Conn. 06749.

Kemamide® E180 fatty amide Is a mold release agent from Chemtura Corporation, Middlebury, Conn. 06749.

Silane A-1100 refers to is 3-aminopropyltriethoxysilane CAS No. [000919-30-2].

### Comparative Examples 1-6

Compositions of Comparative Examples C1-C3, listed in Table 1, were prepared according to the methods disclosed above. Comparative Example C3 illustrates the physical properties of virgin PA 66, and reinforcing agent with no functionalized rubber present. Comparative Examples C1 and C2 illustrate the effect of having 3.95 wt percent functionalized rubber present. C1 and C2 show a significant drop in tensile strength (TS) as compared to the virgin PA 66 with no functionalized rubber present.

Compositions of Comparative Examples C4-C6, listed in Table 1, were prepared according to the methods disclosed above. Comparative Example C6 illustrates the physical properties of high purity PCR PA 66 (97 wt % PA 66 and less than 1 wt % polypropylene), and reinforcing agent with no functionalized rubber present. Comparative Examples C4 and C5 illustrate the effect of having 3.95 wt percent functionalized rubber present. C4 and C5 show a significant drop in tensile strength (TS) as compared to the high purity PCR PA 66 with no functionalized rubber present.

Thus, addition of functionalized rubber to virgin PA 66 or high purity PCR PA66 results in a drop in tensile strength of the compounded compositions. This is the result typically expected by one of skill in the art.

TABLE 1
Comparative Examples illustrating the typical effect of
toughener on properties

| | Example | | | | | |
|---|---|---|---|---|---|---|
| | C1 | C2 | C3 | C4 | C5 | C6 |
| Polyamide 66 | 75.01 | 75.01 | 78.96 | | | |
| PCR-2 PA 66 | | | | 76.15 | 76.15 | 80.10 |
| Glass Fiber | 5 | 5 | 5 | 5 | 5 | 5 |
| Functionalized | 3.95 | | | 3.95 | | |
| rubber-1 | | | | | | |
| Functionalized | | 3.95 | | | 3.95 | |
| rubber-2 | | | | | | |
| Clay | 13.83 | 13.83 | 13.83 | 12.71 | 12.71 | 12.71 |
| C-Black | 1.55 | 1.55 | 1.55 | 1.55 | 1.55 | 1.55 |
| Copper HS | 0.30 | 0.30 | 0.30 | 0.30 | 0.30 | 0.30 |
| Silane A-1100 | 0.21 | 0.21 | 0.21 | 0.19 | 0.19 | 0.19 |
| Lubricant | 0.15 | 0.15 | 0.15 | 0.15 | 0.15 | 0.15 |

Physical Properties

| | | | | | | |
|---|---|---|---|---|---|---|
| MV (Pas · sec) | 148 | 140 | 132 | 90 | 83 | 69 |
| TS (MPa) | 86 | 80 | 102 | 87 | 84 | 93 |
| EB (%) | 3.7 | 3.8 | 3.3 | 3.0 | 3.9 | 2.3 |
| HDT (° C.) | 120 | 164 | 165 | 156 | 146 | 168 |
| Ash, 25 min/ | 19.5 | 18.7 | 18.9 | 18.8 | 20.2 | 18.5 |
| 600° C. (%) | | | | | | |

### Examples 1-4 and Comparative Examples C7 and C8

Compositions of Examples 1-4 and Comparative Examples C7-C8, listed in Table 2, were prepared according to the methods disclosed above. Comparative Example C7 illustrates the physical properties of post consumer recycled polyamide 66, having a polyamide 66 content of 75 weight percent and polypropylene content of about 15 weight per cent, and reinforcing agent with no functionalized rubber present. Examples 1 and 2 illustrate the effect of having 3.95 wt percent functionalized rubber present. Examples 1 and 2 show a significant increase in tensile strength (TS) as compared to the post consumer recycled polyamide 66 with no functionalized rubber present.

Likewise, comparison of Examples 3 and 4 to Comparative Example C8 show a significant increase in TS as well; indicating that the trend toward higher tensile strength is not confined to a single type of functionalized rubber.

Thus, addition of functionalized rubber to post consumer recycled polyamide 66, having a polyamide 66 content of 75 weight percent and polypropylene content of about 15 weight per cent, results in an increase in tensile strength of the compounded compositions. These results are surprising and unexpected, as compared to the results of virgin PA 66 (C1-C3) and high purity PCR (C4-C6).

TABLE 2
Examples and Comparative Examples.

| | Example | | | | | |
|---|---|---|---|---|---|---|
| | 1 | 2 | C7 | 3 | 4 | C8 |
| PCR-1 PA 66 | 82.96 | 82.96 | 86.91 | 80.96 | 80.96 | 84.91 |
| Glass Fiber | 5 | 5 | 5 | 7 | 7 | 7 |
| Functionalized | 3.95 | | | 3.95 | | |
| rubber-1 | | | | | | |
| Functionalized | | 3.95 | | | 3.95 | |
| rubber-2 | | | | | | |
| Clay | 6 | 6 | 6 | 6 | 6 | 6 |
| C-Black | 1.55 | 1.55 | 1.55 | 1.55 | 1.55 | 1.55 |
| Silane A-1100 | 0.09 | 0.09 | 0.09 | 0.09 | 0.09 | 0.09 |
| Copper HS | 0.30 | 0.30 | 0.30 | 0.30 | 0.30 | 0.30 |
| Lubricant | 0.15 | 0.15 | 0.15 | 0.15 | 0.15 | 0.15 |

Physical Properties

| | | | | | | |
|---|---|---|---|---|---|---|
| MV (Pas · sec) | 74 | 66 | 53 | 72 | 76 | 62 |
| TS (MPa) | 71 | 72 | 66 | 77 | 79 | 74 |
| EB (%) | 3.0 | 3.0 | 1.9 | 2.7 | 2.7 | 1.8 |
| HDT (° C.) | 134 | 153 | 173 | 191 | 180 | 210 |
| Ash, 25 min/ | 17.0 | 16.5 | 17.1 | 17.9 | 18.1 | 16.4 |
| 600° C. (%) | | | | | | |

We claim:

1. A thermoplastic composition comprising
a) 80 to 96 weight percent of a recycled thermoplastic comprising polyamide resin, polyolefin and mineral filler, wherein said recycled thermoplastic comprises at least 60 weight percent content of recycled polyamide selected from the group consisting of polyamide 66, polyamide 6, blends of polyamide 66 and polyamide 6, and copolymers having repeat units of polyamide 66 and polyamide 6; and at least 4 weight per cent content of polyolefin, and wherein said recycled polyamide content is equal to the per cent nitrogen content as compared to the nitrogen content of a pure polyamide 66 standard, said nitrogen content being determined by a Nitrogen Combustion Analysis Determination Method; and said polyolefin content is as determined by subtraction of the polyamide content and mineral filler content, as determined from Nitrogen combustion analysis and Ash Analysis, respectively, from the total weight of recycled thermoplastic;
b) 2 to 8 weight percent of a functionalized rubber;
c) 2 to less than 10 weight percent reinforcing agent having a minimum aspect ratio of 3; and
d) 0 to 5 weight percent of additives selected from the group. consisting of mold release, flow enhancers, thermal stabilizers, antistatic agents, blowing agents, lubricants, plasticizers, and colorant and pigments;
wherein the weight percents of a), b), c), and d) are based on the total weight of the thermoplastic resin composition.

2. The thermoplastic composition of claim 1 wherein the reinforcing agent is glass fiber.

3. The thermoplastic composition of claim 1 wherein the recycled polyamide is polyamide 66.

4. The thermoplastic composition of any of claim 1 wherein the recycled thermoplastic includes at least 8 weight per cent content of polyolefin.
